(19) United States
(12) Patent Application Publication
(10) Pub. No.: US 2024/0302000 A1
(43) Pub. Date: Sep. 12, 2024

(54) COMPRESSED HYDROGEN VEHICLE FUELING SYSTEM HAVING SONIC CHOKE FLOW CONTROL

(71) Applicant: Boyd Hydrogen LLC, Spring Lake, NJ (US)

(72) Inventors: Robert Walter Boyd, Spring Lake Heights, NJ (US); Lawrence Stephen Fox, Dover, NJ (US)

(21) Appl. No.: 18/598,422

(22) Filed: Mar. 7, 2024

Related U.S. Application Data
(60) Provisional application No. 63/450,474, filed on Mar. 7, 2023.

(51) Int. Cl. F17C 5/06

(52) U.S. Cl. CPC F17C 5/06; F17C 2201/0104; F17C 2221/012; F17C 2265/065; F17C 2270/0168

(57) ABSTRACT

A compressed hydrogen vehicle fuel dispensing system may include a sonic choke having an orifice defined in a generally cylindrical body having a throat between two opposed frustoconical sections. The system may include a plurality of sonic chokes connected in parallel with a plurality of hydrogen storage banks and configured to provide compressed hydrogen to a vehicle at desired flow rates. The fuel dispensing system may include a plurality of flow control valves configured to direct the flow of compressed hydrogen to the plurality of sonic chokes to control the flow rate of compressed hydrogen to the vehicle storage system. A method of fueling a vehicle with a compressed hydrogen is also presented.

### CROSS-REFERENCE TO RELATED APPLICATIONS

This application claims the benefit of and priority to U.S. Provisional Application No. 63/450,474, titled “Compressed Hydrogen Vehicle Fueling System having Sonic Choke Flow Control”, filed Mar. 7, 2023, the contents of which are incorporated by reference herein.

### TECHNICAL FIELD

This disclosure is directed to vehicle fueling systems, more particularly to compressed hydrogen vehicle fueling systems using one or more sonic chokes for flow control.

### BACKGROUND

The history of flowrate control methods for fueling compressed hydrogen and hydrogen storage systems on vehicles includes both fixed orifice and variable orifice approaches. Fixed orifice flow control methods are used commercially for natural gas vehicle fueling and for 350 bar (H35) fueling for hydrogen powered industrial trucks (HPIT) i.e., electric powered forklifts and other material handling vehicles.

For high pressure fueling systems, e.g., 700 bar (H70) hydrogen vehicle fueling, the standard commercial hydrogen vehicle fueling protocol uses a variable area valve to manage flow rate. This standard variable area valve method of flow control for H70 vehicle fueling has some significant drawbacks including hydrogen leaks from the rising stem seal on the variable area valve, significant temperature rise downstream of the valve, and multiple layers of protection to assure that the valve does not open too much and fuel the vehicle too fast.

As the hydrogen vehicle market expands to support heavy duty trucks with much larger fuel systems, the problems controlling the larger variable area valves to support higher flow rates have gotten more difficult to manage and the larger diameter valve stem on the larger valve is even more prone to hydrogen leaks to the atmosphere: fugitive emissions that increase over time as the variable area valve operates.

### BRIEF SUMMARY

Replacing the variable area orifice with one or more sonic chokes to control the fuel flow rate eliminates a problematic fugitive emission source in the fuel dispensing system and reduces the layers of protection used to reduce the risk of fueling vehicles at too high a flow rate.

When compared with the use of other flow control methods, the use of precision manufactured sonic chokes enable much higher hydrogen density and lower velocity throughout the rest of dispenser components, the fueling hose assembly and into the vehicle.

The use of precision manufactured sonic chokes to control the flow of hydrogen minimizes the heating associated with the Joule-Thompson effects of hydrogen pressure loss at the temperatures and pressures typical of hydrogen vehicle fueling. This results in lower cooling costs associated with hydrogen vehicle fueling and a safe-by-design flow control solution with no moving parts.

In some aspects, the techniques described herein relate to a compressed hydrogen vehicle fueling system, including: a sonic choke having an orifice defined in a generally cylindrical body, wherein an end of the body defines a frustoconical portion; a plurality of sonic chokes connected in parallel with a plurality of hydrogen storage banks and configured to provide compressed hydrogen to a vehicle at desired flow rates; a plurality of storage bank valves configured to provide a flow of compressed hydrogen from the plurality of hydrogen storage banks to the plurality of sonic chokes; and a plurality of flow control valves configured to direct the flow of compressed hydrogen to the plurality of sonic chokes.

In some aspects, the techniques described herein relate to a method of fueling a vehicle with a compressed hydrogen, including providing a flow of compressed hydrogen from a plurality of hydrogen storage banks to a plurality of sonic chokes connected in parallel with a plurality of hydrogen storage banks using a plurality of storage bank valves; and directing the flow of compressed hydrogen to the plurality of sonic chokes to regulate a flowrate of hydrogen to a vehicle storage system.

In some aspects, the techniques described herein relate to a method of fueling a vehicle with compressed hydrogen, including directing a flow of compressed hydrogen from a plurality of hydrogen storage banks to one or more sonic chokes.

### BRIEF DESCRIPTION OF THE DRAWINGS

The present invention is now described, by way of example with reference to the accompanying drawings, in which:

FIG. 1 illustrates an H2 sonic choke designed for a hydrogen fueling according to some embodiments.

FIG. 2 is a schematic diagram of an H70 hydrogen fueling system using three sonic chokes to regulate the flow from a cascade of compressed hydrogen storage systems as the first phase of the fueling process according to some embodiments.

FIG. 3 is a schematic diagram of an H35 hydrogen fueling system using three sonic chokes to regulate the flow from a cascade of compressed hydrogen storage systems as the first phase according to some embodiments.

FIG. 4 is a flow chart of a method of fueling a vehicle with compressed hydrogen according to some embodiments.

FIG. 5 is a flow chart of another method of fueling a vehicle with compressed hydrogen according to some embodiments.

### DETAILED DESCRIPTION

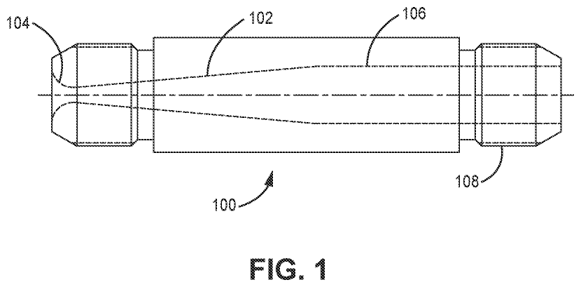

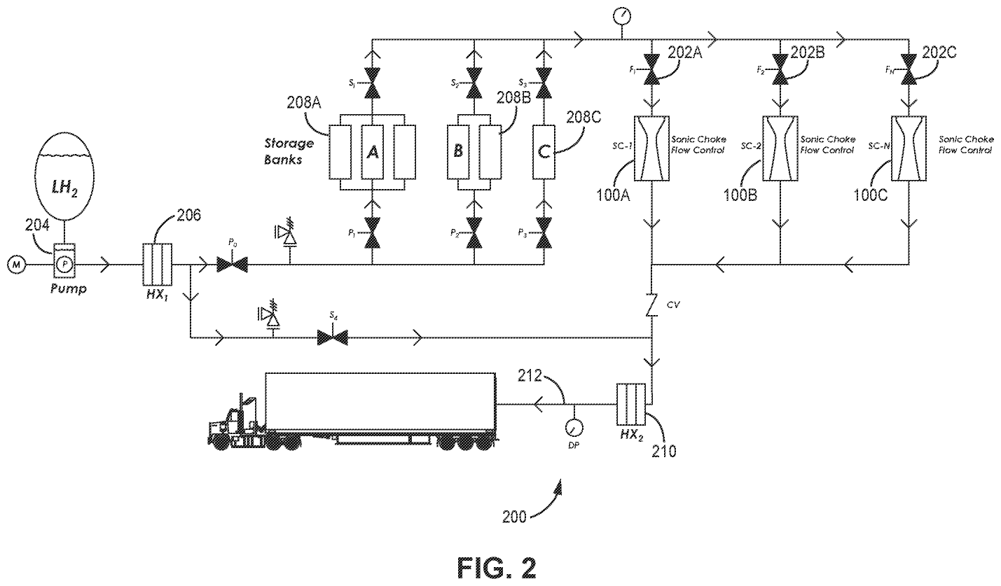

A non-limiting example of a sonic choke 100 is illustrated in FIG. 1. The sonic choke 100 is designed to deliver compressed hydrogen at flow rate of 300 grams per second at a supply pressure of 450 bar. The sonic choke 100 may be formed of 316 stainless in the form of two cones, or frustoconical sections 102, 104, and a throat section 106 having a threaded pipe nipple 108 with a nominal outer diameter of about one inch. In alternative embodiments, this treaded pipe nipple may be replaced with a weldable section. This embodiment of the sonic choke 100 shown is a flow control device used to manage flow during the pressure equalization steps of the fueling process shown in the diagram of FIG. 2. Other embodiments of the sonic choke may be envisioned to support different flowrates and supply pressures as needed by the particular application. These alternative embodiments may also have different dimensions.

As shown in FIG. 2, a compressed hydrogen vehicle fueling system 200 includes three sonic chokes 100A, 100B, 100C as detailed in FIG. 1 that are arranged and connected in parallel in which a first sonic choke 100A may be configured to provide compressed H2 at a flow rate of 300 grams per second, a second sonic choke 100B may be configured to provide compressed H2 at 200 grams per second and a third sonic choke 100C may be configured to provide compressed H2 at 100 grams per second at maximum storage bank pressure. These flow rates are examples, the actual flow rates and the number of parallel sonic chokes depends on the range of vehicle onboard storage system capacities (e.g., 2 to 100 kg) that are to be fueled. Alternative embodiment of the compressed hydrogen vehicle fueling system may contain additional sonic chokes connected in parallel with the first, second, and third sonic chokes 100A, 100B, 100C.

Three flow control valves 202A, 202B, and 202C are opened in response to a determination of vehicle on-board storage system size and mass average temperature of the hydrogen measured at the fueling hose assembly 212.

When vehicles are not fueling, the pump 204 is compressing hydrogen through the first heat exchanger 206 into hydrogen storage banks 208C, 208B, and 208A, in that order of priority, filling them to the compressed storage system maximum operating pressure (MOP). The first heat exchanger 206 warms the hydrogen to a temperature greater than −40° C. or the minimum rated temperature of the storage banks 208C, 208B, and 208A.

The vehicle fueling process begins with a series of equalizations with storage banks 208C, 208B, and 208A in that order with the flow passing through the second heat exchanger 210 to cool the hydrogen after the sonic choke(s) 100A, 100B, 1009C and before the fueling hose assembly 212.

During the equalization process, the pump flow to the storage banks may be first used in the second heat exchanger 210 to achieve −20° C. to −40° C. precooling before dispensing to the vehicle and then back to first heat exchanger 206 before supplying hydrogen to storage banks 208C, 208B, and 208A in that order.

Alternatively, during the equalization process, the flow from the pump may be added to the flow from the sonic chokes to enable cooling of the hydrogen coming from storage and achieve higher flow rates to the vehicle than if pumping to the vehicle directly.

Heat exchanger 206 may be used to cool the hydrogen supply to the vehicle to achieve faster fueling in hot weather climates.

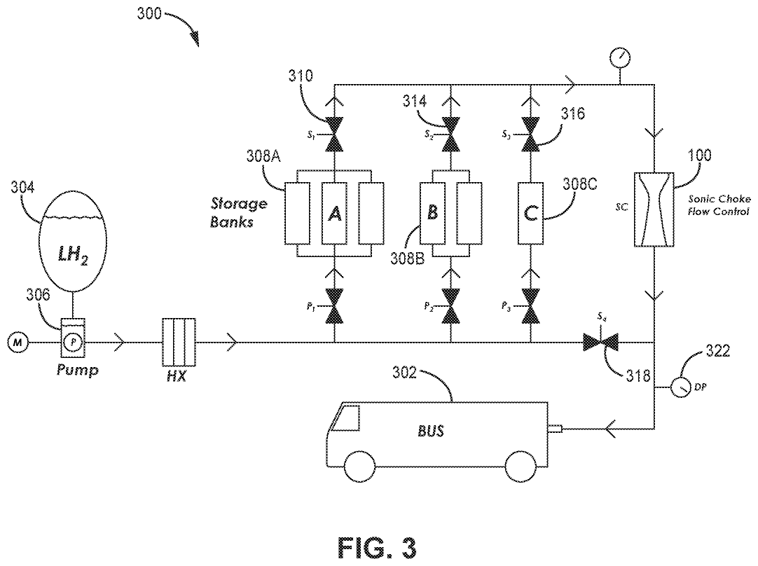

FIG. 3 illustrates a compressed hydrogen bus fueling station 300 in which a single sonic choke 100 is used to regulate the flow from a cascade of 450 bar storage banks into an H35 rated on-board storage system 302 of a hydrogen fuel cell bus. This hydrogen bus fueling station 300 is supplied by liquid hydrogen that is delivered by a tanker truck (not shown) and in stored in a stationary tank 304. A liquid pump 306 is used to pressure transfer the hydrogen to the on-board storage system 302 of the hydrogen fuel cell bus or to local storage banks 308A, 308B, 308C. The pump 306 may be used to top off the on-board storage system 302 of the local 450 bar storage banks 308A, 308B, 308C when no vehicles are being filled.

When a vehicle is presented to be fueled, it is first connected to the on-site hydrogen storage bank 308A by opening valve 310 and allowing the on-site storage system to equalize with the containers in the bus through the dispenser hose 312 with the flow rate controlled by the sonic choke 100.

After equalization with the first storage bank, the valve 310 is closed and the valve 314 is opened to equal start the equalization process with storage bank 308B if the target pressure has not yet been achieved.

After equalization with the second storage bank 308B, the valve 314 is closed and the valve 316 is opened to start the equalization process with storage banks 308C if the target pressure has not yet been achieved.

Throughout the sequence of equalization steps, the fueling flow rate is controlled by the sonic choke 100.

After the equalization steps, the valve 318 is opened and the fueling process continues with output from the liquid pump 306 being directed through the heat exchanger 320 to the hydrogen fuel cell bus if the target pressure has not yet been achieved.

When the fueling hose pressure sensor 322 indicates the target pressure is achieved, the fueling process is terminated, all of the supply valves 310, 314, 316, 318 are closed.

The use of one or more precision manufactured sonic chokes 100 enable a “safe-by-design” flow control method for the high speed fueling for hydrogen vehicles that is particularly applicable to heavy duty fueling vehicle with between 10 and 1200 kg for road tractors or 2000 kilograms or more stored hydrogen on board a train or mining haul vehicle.

The use of a precision manufactured sonic chokes 100 enables much higher hydrogen density and lower velocity throughout the rest of dispenser components, the fueling hose assembly, and into the vehicle. Less pressure loss equates to less heating of the flowing hydrogen that is associated with the Joule-Thompson effects of high pressure hydrogen transfer.

The benefits are lower cooling costs associated with hydrogen vehicle fueling, a safe-by-design flow control solution with no moving parts, and a reduction of the fugitive emissions associated with the variable area control valve. The simplicity of this flow control method requires fewer layers of protection than a variable area valve control system managing average pressure ramp rise.

The use of a precision manufactured sonic chokes 100 is applicable to all classes of hydrogen powered vehicles with small onboard storage capacity such as motorcycles or forklift truck, to light duty road vehicles with typically 4 to 8 kg fuel capacity to class 8 trucks with 60 to 120 kg fuel capacity, and up to trains, boats, or airplanes with 1000 kg or more of onboard fuel capacity.

The use of one or more precision manufactured sonic chokes in place of a variable area orifice eliminates a source of fugitive emissions and eliminates a maintenance problem that currently plagues all hydrogen dispensing systems that use a variable area control valve to manage the flow when refueling hydrogen powered vehicles with on-board compressed hydrogen storage systems.

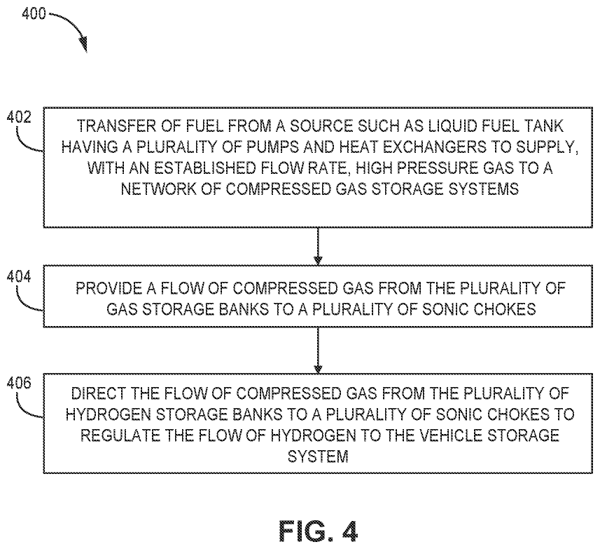

A method 400 of fueling a vehicle with compressed hydrogen is illustrated in FIG. 4.

At STEP 402 hydrogen is transferred from a liquid hydrogen tank to a plurality of compressed hydrogen storage banks utilizing a plurality of pumps. In some embodiments, this step includes transferring hydrogen from a source such as liquid hydrogen tank having a plurality of pumps and heat exchangers to supply high pressure hydrogen to a network of compressed hydrogen storage systems with an established flow rate.

At STEP 404, a flow of compressed hydrogen is provided from the plurality of hydrogen storage banks to a plurality of sonic chokes. In some embodiments, this step includes providing a flow of compressed hydrogen from the plurality of hydrogen storage banks to a plurality of sonic chokes connected in parallel with a plurality of hydrogen storage banks using a plurality of storage bank valves.

At STEP 406, the flow of compressed hydrogen to the to the vehicle storage system is regulated. In some embodiments, this step includes directing the flow of compressed hydrogen from the plurality of hydrogen storage banks to a plurality of sonic chokes to regulate the flow of hydrogen to the vehicle storage system.

In some embodiments the plurality of flow control valves is opened in response to determination of a vehicle on-board storage system capacity and mass average temperature of the hydrogen measured at a fueling hose assembly.

In some embodiments a flow rate of one sonic choke in the plurality of sonic chokes is different than another sonic choke in the plurality of sonic chokes.

In some embodiments use of the plurality of sonic chokes as a flow control device provides up to 90% pressure recovery downstream of the sonic choke enables higher hydrogen density and lower linear velocity as hydrogen flows through downstream dispenser components and fueling hose assembly and into the vehicle.

In some embodiments the plurality of sonic chokes controls the flow of hydrogen minimizes the heating associated with Joule-Thompson effects of hydrogen pressure loss, thereby resulting in reduced cooling costs associated with hydrogen vehicle fueling.

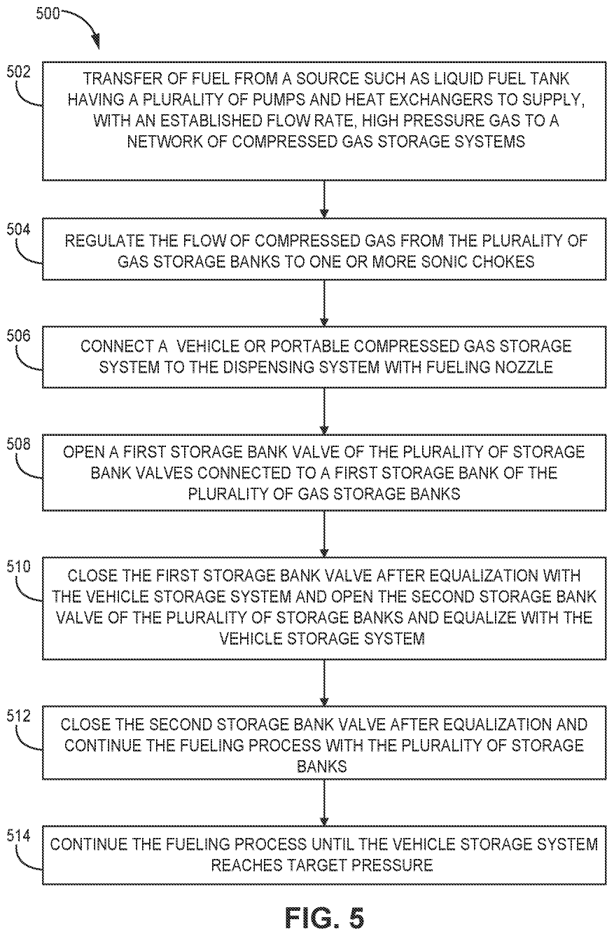

Another method 500 of fueling a vehicle with compressed hydrogen is illustrated in FIG. 5.

At STEP 502, liquid hydrogen is transferred from a liquid hydrogen source to a plurality of interconnected compressed hydrogen storage systems utilizing a plurality of pumps. In some embodiments, this step includes transferring hydrogen from a source such as liquid hydrogen tank having a plurality of pumps and heat exchangers to supply, with an established flow rate, high pressure hydrogen to a network of compressed hydrogen storage systems.

At STEP 504, a flow of compressed hydrogen from the plurality of hydrogen storage banks to one or more sonic chokes is regulated. In some embodiments, this step includes directing the flow of compressed hydrogen from the plurality of hydrogen storage banks to one or more sonic chokes.

In some embodiments use of the sonic choke as a flow control device provides up to 90% pressure recovery downstream of the sonic choke enables higher hydrogen density and lower hydrogen velocity as it flows through downstream dispenser components and fueling hose assembly and into the vehicle.

In some embodiments the sonic choke controls the flow of hydrogen minimizes the heating associated with Joule-Thompson effects of hydrogen pressure loss, thereby resulting in reduced cooling costs associated with hydrogen vehicle fueling.

At STEP 506 a vehicle is connected to a compressed hydrogen vehicle fueling system. In some embodiments, this step includes connecting a hydrogen vehicle or portable hydrogen storage system to the dispensing system with fueling nozzle.

At STEP 508, a first storage bank valve of the plurality of storage bank valves connected to a first storage bank of the plurality of hydrogen storage banks is opened. In some embodiments, this step includes opening a first storage bank valve of the plurality of storage bank valves connected to a first storage bank of the plurality of hydrogen storage banks and allowing equalization of pressure the first storage bank with a vehicle storage system while a flow rate is controlled by the sonic choke.

At STEP 510, the first storage bank valve is closed after equalization with the first storage bank and a second storage bank valve of the plurality of storage bank valves connected to a second storage bank of the plurality of hydrogen storage banks is opened. In some embodiments, this step includes closing the first storage bank valve after equalization with the vehicle storage system and opening the second storage bank valve of the plurality of storage banks and equalize with the vehicle storage system.

At STEP 512, the second storage bank valve is closed after equalization with the vehicle storage system and continuing the fueling process. In some embodiments, this step includes closing the second storage bank valve after equalization and continuing the fueling process with the plurality of storage banks.

At STEP 514, the fueling process is continued until the vehicle storage system reaches the target pressure. In some embodiments, this step includes continuing the fueling process with direct flow from the pump or compressor until the vehicle storage system reaches target pressure.

In some embodiments the method provides a safe by design flow control method that requires no moving parts and fewer layers of protection than are required for a variable area valve based flow control method.

While the examples presented herein are directed to utilizing compressed hydrogen as a vehicle fuel, other embodiments of systems and methods may be envisioned that utilize compressed hydrogen as a vehicle fuel.

### Discussion of Possible Embodiments

The following are non-exclusive descriptions of possible embodiments of the present invention.

In some aspects, the techniques described herein relate to a compressed hydrogen vehicle fueling system, including: a sonic choke having an orifice defined in a generally cylindrical body, wherein an end of the body defines a frustoconical portion; a plurality of sonic chokes connected in parallel with a plurality of hydrogen storage banks and configured to provide compressed hydrogen to a vehicle at desired flow rates; a plurality of storage bank valves configured to provide a flow of compressed hydrogen from the plurality of hydrogen storage banks to the plurality of sonic chokes; and a plurality of flow control valves configured to direct the flow of compressed hydrogen to the plurality of sonic chokes.

The system of the preceding paragraphs can optionally include, additionally and/or alternatively any, one or more of the following features, configurations and/or additional components.

In some aspects, the techniques described herein relate to a system, further including a plurality of the sonic choke connected in parallel with a plurality of hydrogen storage banks and configured to provide compressed hydrogen to a vehicle at desired flow rates.

In some aspects, the techniques described herein relate to a system, wherein use of the plurality of the sonic choke as a flow control device provides up to 90% pressure recovery downstream of the sonic choke enables higher hydrogen density and lower linear velocity as hydrogen flows through downstream dispenser components and fueling hose assembly and into the vehicle.

In some aspects, the techniques described herein relate to a system, wherein the plurality of the sonic chokes controls the flow of hydrogen minimizing heating associated with Joule-Thompson effects of hydrogen pressure loss, thereby resulting in reduced cooling costs associated with hydrogen vehicle fueling.

In some aspects, the techniques described herein relate to a system, wherein a flow rate of one sonic choke in the plurality of the sonic choke is different than another sonic choke in the plurality of the sonic choke.

In some aspects, the techniques described herein relate to a system, including: the sonic choke connected in parallel with a plurality of hydrogen storage banks and configured to provide compressed hydrogen to a vehicle at a desired flow rate; and a plurality of storage bank valves configured to provide a flow of compressed hydrogen from the plurality of hydrogen storage banks to a plurality of sonic chokes.

In some aspects, the techniques described herein relate to a system, wherein use of the sonic choke as a flow control device provides up to 90% pressure recovery downstream of the sonic choke enables higher hydrogen density and lower hydrogen velocity as it flows through downstream dispenser components and fueling hose assembly and into the vehicle.

In some aspects, the techniques described herein relate to a system, wherein the sonic choke controls the flow of hydrogen, thereby minimizing heating associated with Joule-Thompson effects of hydrogen pressure loss and resulting in reduced cooling costs associated with hydrogen vehicle fueling.

In some aspects, the techniques described herein relate to a system, wherein the system has no moving parts and provides a safe by design flow control system that requires fewer layers of protection than are required for a variable area valve based flow control system.

In some aspects, the techniques described herein relate to a method of fueling a vehicle with a compressed hydrogen, including providing a flow of compressed hydrogen from a plurality of hydrogen storage banks to a plurality of sonic chokes connected in parallel with a plurality of hydrogen storage banks using a plurality of storage bank valves; and directing the flow of compressed hydrogen to the plurality of sonic chokes to regulate a flowrate of hydrogen to a vehicle storage system.

The method of the preceding paragraphs can optionally include, additionally and/or alternatively any, one or more of the following features, configurations and/or additional components.

In some aspects, the techniques described herein relate to a method, wherein a plurality of flow control valves is opened in response to determination of a vehicle on-board storage system capacity and mass average temperature of the hydrogen measured at a fueling hose assembly.

In some aspects, the techniques described herein relate to a method, wherein a flow rate of one sonic choke in the plurality of sonic chokes is different than another sonic choke in the plurality of sonic chokes.

In some aspects, the techniques described herein relate to a method, wherein use of the plurality of sonic chokes as a flow control device provides up to 90% pressure recovery downstream of the sonic choke enables higher hydrogen density and lower hydrogen velocity as it flows through downstream dispenser components and fueling hose assembly and into the vehicle storage system.

In some aspects, the techniques described herein relate to a method, wherein the plurality of sonic chokes controls the flow of hydrogen minimizes heating associated with Joule-Thompson effects of hydrogen pressure loss, thereby resulting in reduced cooling costs associated with hydrogen vehicle fueling.

In some aspects, the techniques described herein relate to a method of fueling a vehicle with compressed hydrogen, including directing a flow of compressed hydrogen from a plurality of hydrogen storage banks to one or more sonic chokes.

The method of the preceding paragraphs can optionally include, additionally and/or alternatively any, one or more of the following features, configurations and/or additional components.

In some aspects, the techniques described herein relate to a method, wherein use of the one or more sonic chokes as a flow control device provides up to 90% pressure recovery downstream of the one or more sonic chokes enables higher hydrogen density and lower hydrogen velocity as it flows through downstream dispenser components and fueling hose assembly and into a vehicle storage system.

In some aspects, the techniques described herein relate to a method, wherein the one or more sonic chokes controls the flow of hydrogen minimizing heating associated with Joule-Thompson effects of hydrogen pressure loss, thereby resulting in reduced cooling costs associated with hydrogen vehicle fueling.

In some aspects, the techniques described herein relate to a method, further including: connecting a vehicle or portable hydrogen storage system to a compressed hydrogen vehicle fueling system; opening a first storage bank valve of a plurality of storage bank valves connected to a first storage bank of the plurality of hydrogen storage banks and allowing equalization of pressure the first storage bank with a vehicle storage system while a flow rate is controlled by the sonic choke; and closing the first storage bank valve after equalization with the vehicle storage system and opening a second storage bank valve of the plurality of storage bank valves connected to a second storage bank of the plurality of hydrogen storage banks and allowing equalization of pressure the first storage bank with a vehicle storage system.

In some aspects, the techniques described herein relate to a method, further including closing the second storage bank valve after equalization with the vehicle storage system; and continuing the fueling process with the plurality of storage banks.

In some aspects, the techniques described herein relate to a method, further including continuing the fueling process until the vehicle storage system reaches target pressure.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. A compressed hydrogen vehicle fueling system, comprising:
a sonic choke having an orifice defined in a generally cylindrical body, wherein an end of the body defines a frustoconical portion;
a plurality of sonic chokes connected in parallel with a plurality of hydrogen storage banks and configured to provide compressed hydrogen to a vehicle at desired flow rates;
a plurality of storage bank valves configured to provide a flow of compressed hydrogen from the plurality of hydrogen storage banks to the plurality of sonic chokes; and
a plurality of flow control valves configured to direct the flow of compressed hydrogen to the plurality of sonic chokes.

2. The system in accordance with claim 1, further comprising a plurality of the sonic choke connected in parallel with a plurality of hydrogen storage banks and configured to provide compressed hydrogen to a vehicle at desired flow rates.

3. The system in accordance with claim 1, wherein use of the plurality of the sonic choke as a flow control device provides up to 90% pressure recovery downstream of the sonic choke enables higher hydrogen density and lower linear velocity as hydrogen flows through downstream dispenser components and fueling hose assembly and into the vehicle.

4. The system in accordance with claim 1, wherein the plurality of the sonic chokes controls the flow of hydrogen minimizing heating associated with Joule-Thompson effects of hydrogen pressure loss, thereby resulting in reduced cooling costs associated with hydrogen vehicle fueling.

5. The system in accordance with claim 1, wherein a flow rate of one sonic choke in the plurality of the sonic choke is different than another sonic choke in the plurality of the sonic choke.

6. The system in accordance with claim 1, comprising:
the sonic choke connected in parallel with a plurality of hydrogen storage banks and configured to provide compressed hydrogen to a vehicle at a desired flow rate; and
a plurality of storage bank valves configured to provide a flow of compressed hydrogen from the plurality of hydrogen storage banks to a plurality of sonic chokes.

7. The system in accordance with claim 6, wherein use of the sonic choke as a flow control device provides up to 90% pressure recovery downstream of the sonic choke enables higher hydrogen density and lower hydrogen velocity as it flows through downstream dispenser components and fueling hose assembly and into the vehicle.

8. The system in accordance with claim 6, wherein the sonic choke controls the flow of hydrogen, thereby minimizing heating associated with Joule-Thompson effects of hydrogen pressure loss and resulting in reduced cooling costs associated with hydrogen vehicle fueling.

9. The system in accordance with claim 1, wherein the system has no moving parts and provides a safe by design flow control system that requires fewer layers of protection than are required for a variable area valve based flow control system.

10. A method of fueling a vehicle with a compressed hydrogen, comprising:
providing a flow of compressed hydrogen from a plurality of hydrogen storage banks to a plurality of sonic chokes connected in parallel with a plurality of hydrogen storage banks using a plurality of storage bank valves; and
directing the flow of compressed hydrogen to the plurality of sonic chokes to regulate a flowrate of hydrogen to a vehicle storage system.

11. The method in accordance with claim 10, wherein a plurality of flow control valves is opened in response to determination of a vehicle on-board storage system capacity and mass average temperature of the hydrogen measured at a fueling hose assembly.

12. The method in accordance with claim 10, wherein a flow rate of one sonic choke in the plurality of sonic chokes is different than another sonic choke in the plurality of sonic chokes.

13. The method in accordance with claim 10, wherein use of the plurality of sonic chokes as a flow control device provides up to 90% pressure recovery downstream of the sonic choke enables higher hydrogen density and lower hydrogen velocity as it flows through downstream dispenser components and fueling hose assembly and into the vehicle storage system.

14. The method in accordance with claim 10, wherein the plurality of sonic chokes controls the flow of hydrogen minimizes heating associated with Joule-Thompson effects of hydrogen pressure loss, thereby resulting in reduced cooling costs associated with hydrogen vehicle fueling.

15. A method of fueling a vehicle with compressed hydrogen, comprising:
directing a flow of compressed hydrogen from a plurality of hydrogen storage banks to one or more sonic chokes.

16. The method in accordance with claim 15, wherein use of the one or more sonic chokes as a flow control device provides up to 90% pressure recovery downstream of the one or more sonic chokes enables higher hydrogen density and lower hydrogen velocity as it flows through downstream dispenser components and fueling hose assembly and into a vehicle storage system.

17. The method in accordance with claim 15, wherein the one or more sonic chokes controls the flow of hydrogen minimizing heating associated with Joule-Thompson effects of hydrogen pressure loss, thereby resulting in reduced cooling costs associated with hydrogen vehicle fueling.

18. The method in accordance with claim 15, further comprising:
connecting a vehicle or portable hydrogen storage system to a compressed hydrogen vehicle fueling system;
opening a first storage bank valve of a plurality of storage bank valves connected to a first storage bank of the plurality of hydrogen storage banks and allowing equalization of pressure the first storage bank with a vehicle storage system while a flow rate is controlled by the sonic choke; and
closing the first storage bank valve after equalization with the vehicle storage system and opening a second storage bank valve of the plurality of storage bank valves connected to a second storage bank of the plurality of hydrogen storage banks and allowing equalization of pressure the first storage bank with a vehicle storage system.

19. The method in accordance with claim 18, further comprising:
closing the second storage bank valve after equalization with the vehicle storage system; and
continuing the fueling process with the plurality of storage banks.

20. The method in accordance with claim 19, further comprising:
continuing the fueling process until the vehicle storage system reaches target pressure.
